(19) United States
(12) Patent Application Publication
(10) Pub. No.: US 2024/0021846 A1
(43) Pub. Date: Jan. 18, 2024

(54) HUMIDIFICATION DEVICE FOR A FUEL CELL SYSTEM

(71) Applicant: Robert Bosch GmbH, Stuttgart (DE)

(72) Inventors: Dirk Schnittger, Ludwigsburg (DE); Janis Zeiser, Schwieberdingen (DE); Reinhard Schmid, Remshalden (DE); Wolfgang Sander, Weissach (DE)

(21) Appl. No.: 18/044,284

(22) PCT Filed: Aug. 12, 2021
(86) PCT No.: PCT/EP2021/072494

§ 371 Date: Mar. 7, 2023

(30) Foreign Application Priority Data
Sep. 14, 2020 (DE) 10 2020 211 494.3

(51) Int. Cl. H01M 8/04119

(52) U.S. Cl. CPC H01M 8/04141

(57) ABSTRACT

The invention relates to a humidification device (1) for a fuel cell system (2), comprising an inlet (3) and an outlet (4) for a first medium to be humidified, preferably cathode supply air, and an inlet (5) and an outlet (6) for an aqueous second medium, preferably cathode exhaust air. According to the invention, the humidification device (1) is modularly designed and has at least one module element (11, 12, 13) into which at least one shut-off valve (7, 8) and/or at least one bypass valve (9, 10) is or are integrated.

The invention furthermore relates to a fuel cell system (2) having a humidification device (1) according to the invention.

### BACKGROUND

The invention relates to a humidification device for a fuel cell system. In addition, the invention relates to a fuel cell system having a humidification device according to the invention.

In order to generate energy, fuel cells, for example, a plurality of fuel cells of a fuel cell system connected to a fuel cell stack, require a) a fuel, typically hydrogen, supplied via an anode path to an anode of the fuel cell stack, and b) oxygen, supplied via a cathode path to a cathode of the fuel cell stack. Air usually serves as an oxygen supplier, taken from the environment. Because the energy conversion process requires a certain mass air flow and a certain pressure level, the cathode-side supplied air is compressed with the aid of an air compressor arranged in the cathode supply air path. During compression, the air heats up such that, in the cathode supply air path, a cooling device for cooling the compressed air is typically arranged downstream of the air compressor. In addition, a humidification device is generally provided in the cathode supply air path, with which the compressed air can be humidified. The humidification is intended to prevent drying of the membranes of the fuel cells of the fuel cell stack. For humidification, humid cathode exhaust air exiting the fuel cell stack can be used, which is discharged via a cathode exhaust air path and passed through a humidification device, through which the cathode supply air is also directed. For this purpose, the humidification device is arranged in the cathode air path and the cathode exhaust air path.

The cathode air path and the cathode exhaust air path further include shut-off valves for separating the fuel cell stack from the air supply in the event of shutdown. Further, bypass valves arranged in bypass paths can be present as further components in order to circumvent the humidification device and/or the fuel cell stack. Because the flow control between the various components is typically realized via resilient hoses, each component must be secured separately, for example, to a common frame or post. The separate fastening of the individual components increases the cost of assembly. In addition, sufficient design space for the elastic hoses must be reserved.

The problem addressed by the present invention is therefore to simplify the construction of a fuel cell system so that it is easier to assemble. Design space is also to be saved.

To solve the problem, the humidification device for a fuel cell system is proposed. Moreover, a fuel cell system having a humidification device according to the present invention is specified.

### SUMMARY

The humidification device proposed for a fuel cell system comprises an inlet and an outlet for a first medium to be humidified, preferably cathode supply air, and an inlet and an outlet for an aqueous second medium, preferably cathode exhaust air. According to the invention, the humidification device is modularly designed and has at least one module element into which at least one shut-off valve and/or at least one bypass valve is or are integrated.

Due to the proposed integration of at least one shut-off valve and/or at least one bypass valve into the humidification device, the complexity of a fuel cell system in which the humidification device is used can be significantly reduced. This is because a separate attachment is no longer necessary for an integrated valve. If a valve is integrated into the humidification device, a valve housing can also be omitted. Moreover, the connection of the at least one integrated valve within the humidification device can be realized via channels so that hose connections are unnecessary. The otherwise typical connection parts, such as flanges, hose nozzles, and/or quick couplings, are thus also omitted. With the elimination of these interfaces, the robustness of the system also increases.

The module elements of the humidification device can be pre-assembled and then installed as a structural unit, for example inserted into and attached to a post of a fuel cell system. This facilitates the final assembly. In addition, a compact arrangement can be created. Further, with the reduction of the design space requirement, there is an increased power density of the fuel cell system into which the humidification device is used.

Furthermore, with the aid of the proposed humidification device, the dead volume in the fuel cell system can be reduced. As a result, the dynamic response with respect to pressure build-up and efficiency also improves.

According to a preferred embodiment of the invention, the inlet for the medium to be humidified is configured in a first module element. This can be embodied as an inlet end cap, for example. Further, it is proposed that the outlet for the medium to be humidified is configured in a second module element. This can in particular be embodied as an outlet end cap. Due to the arrangement of the inlet and the outlet in different module elements, for example in the two end caps, the space required for the humidification can be provided via the spacing of the module elements from one another.

The inlet and outlet for the aqueous medium are preferably configured in a third module element. This can in particular be embodied as a humidification device function group. Thus, a humidification device that operates according to the counter-current principle can be easily formed. The third module element is preferably arranged between the first and second module elements, preferably in such a way that the orientation of the third module element with respect to the first and second module elements corresponds to the main flow direction of the medium to be humidified through the third module element.

The at least one shut-off valve is preferably integrated into the humidification device in the region of a cathode air path and/or a cathode exhaust air path. Thus, with the aid of the at least one shut-off valve, the air supply to a fuel cell stack of the fuel cell system can be blocked. This is particularly relevant in the event of a shutdown, so that the energy conversion process within the fuel cells of the fuel cell stack is safely interrupted. Typically, a shut-off valve is provided in both the cathode air path and the cathode exhaust air path, respectively. Both shut-off valves can be integrated into the proposed humidification device.

The at least one bypass valve, which is integrated into the humidification device, can in particular be a bypass valve for circumventing a fuel cell stack of the fuel cell system or for circumventing the humidification device itself or its functional group.

According to a first preferred embodiment of the invention, a shut-off valve and a bypass valve are integrated into the first module member and into the second module member, respectively. The valves are thus evenly distributed among the two module elements. The design space available for each module element is thus optimally utilized.

According to a second preferred embodiment of the invention, the first module member comprises two shut-off valves and at least one bypass valve. The cathode exhaust air path consequently passes through the first module element. As the complexity of the first module element increases, the complexity of the second module element decreases. In this way, the respective design space ratios can be optimally accounted for.

According to a third preferred embodiment of the invention, at least one shut-off valve and/or at least one bypass valve is or are integrated into the third module member. In the case of a bypass valve for circumventing the humidification device or the functional group of the humidification device, the bypass path can thus be kept particularly short.

In a further development of the invention, it is proposed that a sensor block be integrated into at least one module element. With the aid of the sensor block, several sensors can be gathered together to form a structural unit, so that assembly is further simplified. By integrating the sensor block into the humidification device, design space can also be saved. Preferably, the sensor block comprises at least one sensor for pressure and/or temperature measurement and/or for flow rate measurement. Furthermore, the sensor block is preferably integrated into the humidification device in the region of the cathode air path so that the pressure and/or the temperature and/or the flow rate in the cathode air path can be monitored, as these are relevant operational variables.

To solve the aforementioned problem, a fuel cell system is also proposed, which comprises a humidification device according to the invention. Via the inlet and outlet for the medium to be humidified, the humidification device is connected to a cathode air path of the fuel cell system. Via the inlet and the outlet for the aqueous medium, the humidification device is connected to a cathode exhaust air path of the fuel cell system. With the aid of the humidification device according to the invention, the complexity of the fuel cell system can be significantly simplified, because the separate configuration and assembly of at least one shut-off and/or bypass valve is eliminated. Accordingly, as the power density increases, the fuel cell system has a reduced design space requirement.

### BRIEF DESCRIPTION OF THE DRAWINGS

The invention will be explained in more detail in the following with reference to the accompanying drawings. The figures show:

FIG. 1 a schematic illustration of a fuel cell system having a humidification device according to the invention according to a first preferred embodiment,

FIG. 2 a schematic illustration of a fuel cell system having a humidification device according to the invention according to a second preferred embodiment,

FIG. 3 a schematic illustration of a fuel cell system having a humidification device according to the invention according to a third preferred embodiment; and

FIG. 4 a schematic illustration of a fuel cell system having a humidification device according to the invention according to a fourth preferred embodiment.

### DETAILED DESCRIPTION

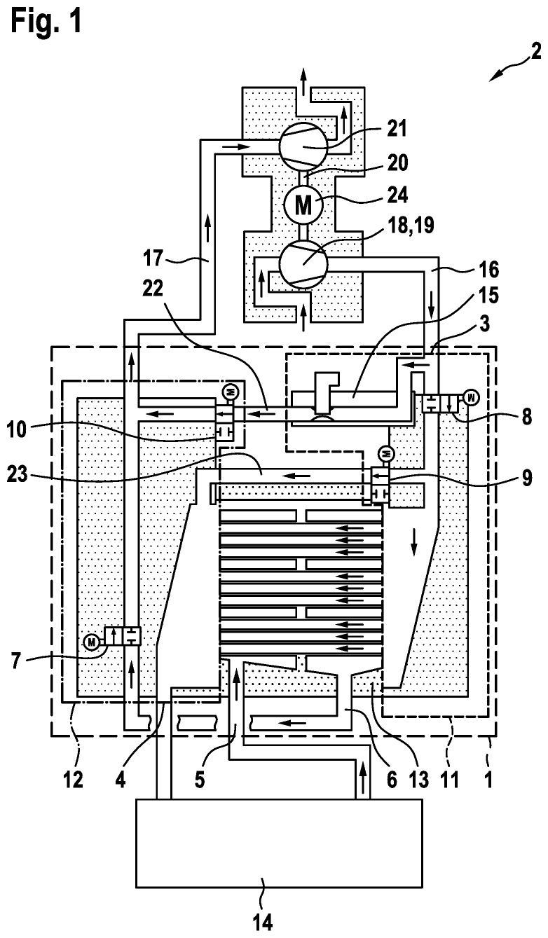

FIG. 1 shows a humidification device 1 according to the present invention, which is integrated into a fuel cell system 2, namely in the region of a cathode air path 16 and a cathode exhaust air path 17 serving to supply air to a fuel cell stack 14. Using an air compressor 18 integrated into the cathode air path 16, the air supplied to the fuel cell stack 14 is previously compressed. The compressed air enters the humidification device 1 via an inlet 3 and exits via an outlet 4. Between the inlet 3 and the outlet 4, the compressed air is fed past a humid air flow, which is humid cathode exhaust air. The humidification device 1 is connected to the cathode exhaust air path 17 via a further inlet 5 and a further outlet 6. In the present case, the cathode exhaust air exiting the humidification device 1 is supplied to an exhaust turbine having a turbine wheel 21 arranged in the cathode exhaust air path 17, said wheel being arranged on a shaft 20 with a compressor wheel 19 of the air compressor 18. In this way, an electric motor drive 24 of air compressor 18 can be unloaded and/or energy can be regained.

The humidification device 1 according to the invention shown in FIG. 1 is modularly designed and, in the present case, comprises three module elements 11, 12, 13. The first module element 11, in which the inlet 3 for the air to be humidified is arranged, forms an inlet end cap. The second module element 12, in which the outlet 4 for the humidified air is arranged, forms an outlet end cap. Therebetween, the third module element 13 is arranged, which forms the actual functional group of the humidification device 1.

In the exemplary embodiment of FIG. 1, a shut-off valve 7, 8 and a bypass valve 9, 10 are integrated into the first and second module elements 11, 12, respectively. The first module element 11 also receives a sensor block 15. Sensor block 15 is integrated into a bypass path 22 in order to bypass the fuel cell stack 14. The bypass path 22 connects the cathode supply air path 16 to the cathode exhaust air path 17, provided the bypass valve 10 is open. In the present case, the latter is integrated into the second module element 12. The bypass valve 9 integrated into the first module element 11 serves to bypass the humidification device 1 or its functional group. For this purpose, the bypass valve 9 is arranged in a bypass path 23, which—outside of the third module element 13—connects the first and the second module elements 11, 12 of the humidification device 1. Downstream of the inlet 3 for the air to be humidified, the shut-off valve 8 is integrated into the first module element 11 of the humidification device 1. Closing the shut-off valve 8 discontinues the supply of air towards the functional group of the humidification device 1 as well as towards the fuel cell stack 14. The shut-off valve 8 is closed in the case of shutdown. The same is true for the further shut-off valve 7, which is integrated into the second module element 12, namely downstream of the functional group of the humidification device 1. In the case of a shutdown, the fuel cell stack 14, including the humidification device 1, is thus separated from the air supply.

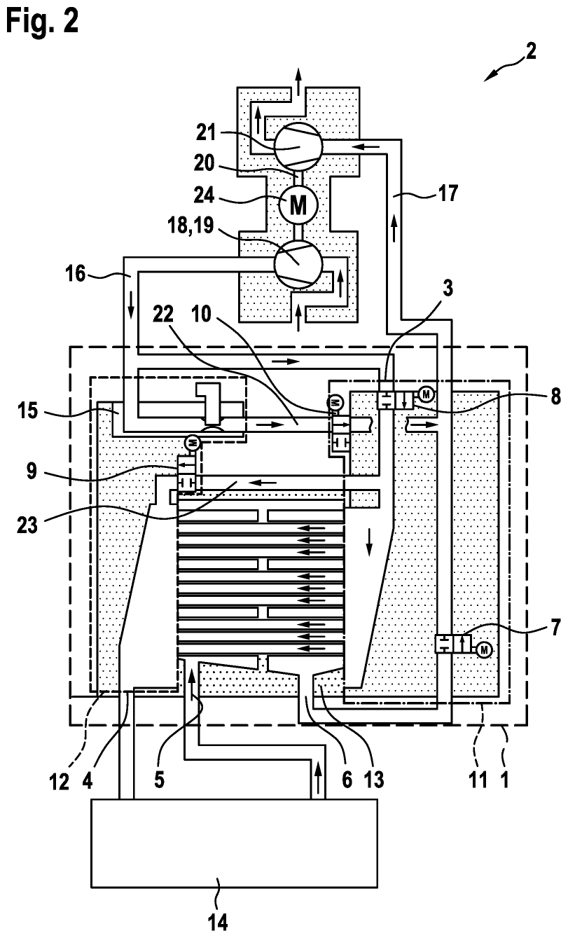

In the exemplary embodiment of FIG. 2, which also shows a modular humidification device 1 having three module elements 11, 12, 13, both shut-off valves 7, 8 and a bypass valve 10 are integrated into the first module element 11. The further bypass valve 9 and the sensor block 15 are integrated into the second module element 12. By contrast to the exemplary embodiment of FIG. 1, the cathode exhaust air path 17 does not pass through the second module element 12, but rather through the first module element 11, so that a different circuiting of the various paths results. This allows the fuel cell system 2 to be adapted to changed design space conditions.

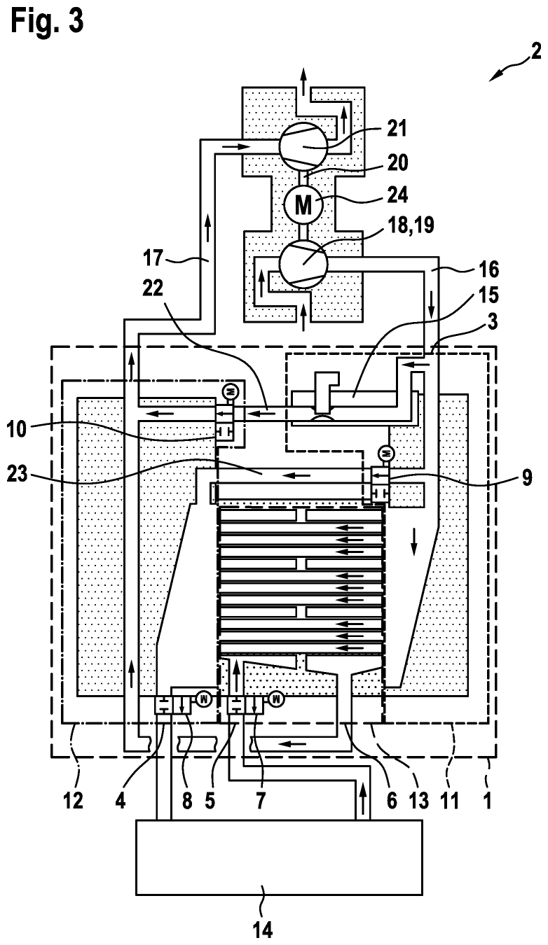

The exemplary embodiment shown in FIG. 3 shows a modification of the exemplary embodiment of FIG. 1, as only the position of the shut-off valves 7, 8 has been changed. The shut-off valve 8 provided for blocking the cathode air path 16 is no longer integrated into the first module element 11 upstream of the functional group of the humidification device 1, but rather downstream of the functional group in the second module element 12. The shut-off valve 7 provided for blocking the cathode exhaust air path 17 is integrated upstream of the functional group of the humidification device 1 into the third module element 13 forming the functional group. Thus, the cathode supply air path 16 and the cathode exhaust air path 17 can be blocked in close proximity to the fuel cell stack 14. With the closing of the shut-off valves 7, 8, the humidification device 1 is also separated from the fuel cell stack 14.

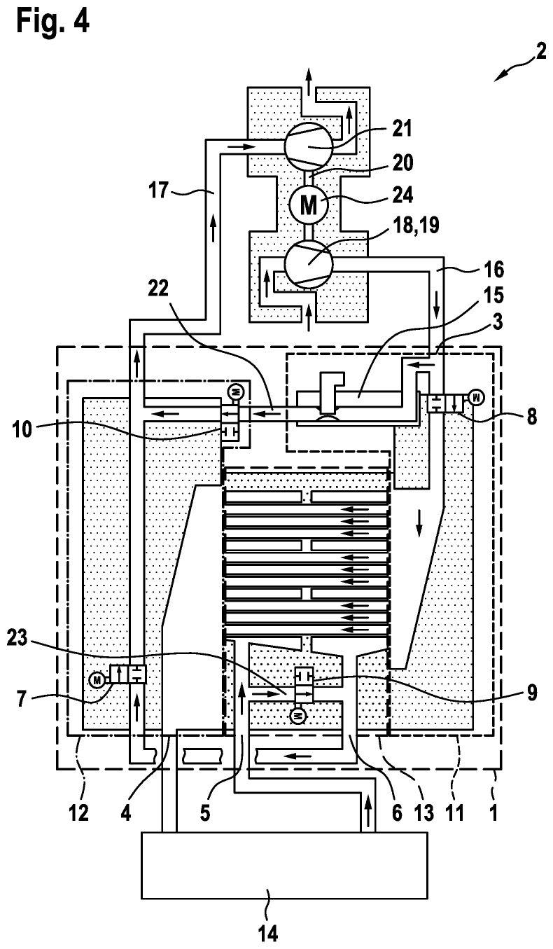

A further modification of the exemplary embodiment of FIG. 1 is shown in FIG. 4. Here, the bypass path 23 has been moved towards the fuel cell stack 14 in order to circumvent the functional group of the humidification device 1. The bypass path 23 has also been integrated into the third module element 13 forming the functional group. In this way, the bypass path 23 can be kept short. In addition, the bypass path 23 can be formed by a channel configured within the third module element 13. This eliminates the need for a hose line, including the required connections. The bypass valve 9 has also been integrated into the third module element 13.

Deviating from the illustrated exemplary embodiments, the modularly constructed humidification device 1 according to the invention can also have fewer than or more than three module elements 11, 12, 13. Moreover, the cathode air path 16 and/or the cathode exhaust air path 17 can include other components not shown in the figures. For example, other components can include a cooling device arranged in the cathode air path 16 for cooling air compressed using the air compressor 18 and/or a water separator arranged in the cathode exhaust air path 17.

1. A humidification device (1) for a fuel cell system (2),
comprising an inlet (3) and an outlet (4) for a first medium to be humidified and an inlet (5) and an outlet (6) for an aqueous second medium,
wherein the humidification device (1) is modularly designed and has at least one module element (11, 12, 13) into which at least one shut-off valve (7, 8) and/or at least one bypass valve (9, 10) is or are integrated.

2. The humidification device (1) according to claim 1,
wherein the inlet (3) for the medium to be humidified is configured in a first module element (11).

3. The humidification device (1) according to claim 1,
wherein the outlet (4) for the medium to be humidified is configured in a second module element (12).

4. The humidification device (1) according to claim 1,
wherein the inlet (5) and the outlet (6) for the aqueous medium are configured in a third module element (13).

5. The humidification device (1) according to claim 1,
wherein the at least one shut-off valve (7, 8) is integrated into a region of a cathode supply air path (16) and/or a cathode exhaust air path (17).

6. The humidification device (1) according to claim 1,
wherein a shut-off valve (7, 8) and a bypass valve (9, 10) are respectively integrated into a first module element (11) and into a second module element (12).

7. The humidification device (1) according to claim 1,
wherein two shut-off valves (7, 8) and at least one bypass valve (9, 10) are integrated into a first module element (11).

8. The humidification device (1) according to claim 1,
wherein at least one shut-off valve (7, 8) and/or at least one bypass valve (9, 10) is or are integrated into a third module element (13).

9. The humidification device (1) according to claim 1,
wherein a sensor block (15) is integrated into at least one module element (11, 12, 13).

10. A fuel cell system (2) comprising a humidification device (1) according to claim 1, wherein the humidification device (1) is connected to a cathode air path (16) via the inlet (3) and the outlet (4) for the medium to be humidified and into a cathode exhaust air path (17) of the fuel cell system (2) via the inlet (5) and the outlet (6) for the aqueous medium.

11. The humidification device (1) according to claim 1, wherein the first medium to be humidified is cathode supply air and the second medium is cathode exhaust air.

12. The humidification device (1) according to claim 2, wherein the first module element (11) is an inlet end cap.

13. The humidification device (1) according to claim 3, wherein the second module element (12) is an outlet end cap.

14. The humidification device (1) according to claim 4, wherein the third module element (13) is a humidification device function group.

15. The humidification device (1) according to claim 1, wherein the inlet (3) for the medium to be humidified is configured in a first module element (11), the outlet (4) for the medium to be humidified is configured in a second module element (12), and the inlet (5) and the outlet (6) for the aqueous medium are configured in a third module element (13).

16. The humidification device (1) according to claim 15, wherein the first module element (11) is an inlet end cap, the second module element (12) is an outlet end cap, and the third module element (13) is a humidification device function group.
